(19) United States
(12) Patent Application Publication
(10) Pub. No.: US 2004/0240967 A1
(43) Pub. Date: Dec. 2, 2004

(54) Binding elements for binding a wide range of thicknesses of stacks of sheets

(76) Inventors: Phillip Crudo, Round Lake, IL (US); Sona Patadia, Hanover Park, IL (US); Tong J Kim, Chicago, IL (US); Mark Kurth, Chicago, IL (US); Michael Prince, Chicago, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/488,193

(22) PCT Filed: Aug. 29, 2002
(86) PCT No.: PCT/US02/27475

Related U.S. Application Data
(60) Provisional application No. 60/315,825, filed on Aug. 29, 2001.

(51) Int. Cl. B42B 9/00

(52) U.S. Cl. 412/16

(57) ABSTRACT

A binding element that may he readily molded, and utilized to bind a range of sizes and thicknesses of stacks of sheets. The elements are molded in a flat sheets with elongated fingers extending from an elongated spine either as individual binding elements, or as an extended length that is then cut to size during an automated assembly process. The elongated fingers are inserted into the prepunched openings in the stack of sheets. The free ends of the fingers are then coupled to the spine, shortening the closed finger loop to an appropriate length for the thickness of the stack of sheets. The excess finger is cut from the finding element and discarded. The actual process steps may be performed in various orders, either sequentially or simultaneously.

### FIELD OF THE INVENTION

The present invention relates to binding elements for holding a plurality of perforated sheets or the like, and more specifically the invention pertains to binding element structures which may be utilized to bind a wide range of thicknesses of stacks of sheets.

### BACKGROUND OF THE INVENTION

Various types of binding elements have been utilized to bind a stack of perforated sheets or the like. Examples of such binding elements which are of a wire comb or hanger-type design are disclosed, for example, in U.S. Pat. No. 2,112,389 to Trussell and U.S. Pat. Nos. 4,832,370 and 4,873,858 to Jones, while machines for assembling such binders are disclosed in U.S. Pat. No. 4,031,585 to Adams, U.S. Pat. No. 4,398,856 to Archer et al., U.S. Pat. No. 4,525,117 to Jones, U.S. Pat. No. 4,934,890 to Flatt, and U.S. Pat. No. 5,370,489 to Bagroky. Other binding devices are disclosed, for example, in the following references: U.S. Pat. Nos. 2,089,881 and 2,363,848 to Emmer, U.S. Pat. No. 2,435,848 to Schade, U.S. Pat. No. 2,466,451 to Liebman, U.S. Pat. No. 4,607,970 to Heusenkveld, U.S. Pat. No. 4,904,103 to Im, U.S. Pat. No. 5,028,159 to Amrich et al., U.S. Pat. No. 4,369,013, Reexamination Certificate B1 4,369,013 and Re. 28,202 to Abildgaard et al. Machines for assembling plastic comb or finger binding elements are disclosed in patents such as U.S. Pat. Nos. 4,645,399 to Scharer, U.S. Pat. No. 4,900,211 to Vercillo, U.S. Pat. No. 5,090,859 to Nanos et al., and U.S. Pat. No. 5,464,312 to Hotkowski et al. The patents are included herein by reference.

Binding elements typically include a spine from which a plurality of fingers extend which may be assembled through perforations in a stack of sheets. This spine may be linear, with or without a longitudinally extending hinge. Alternately, the spine may be formed by sequential bending of a wire, as with wire comb or hanger type binding elements.

Due to the structure of such binding devices, which include predetermined length of fingers for a given binding element, the binding devices are commonly utilized to bind preselected thicknesses of stacks of sheets or, alternately, only a limited range of thicknesses of stacks of sheets. As a result, a user that may have the occasion to bind a larger range of stack thicknesses would be required to maintain an inventory of a range of sizes of binding elements. This inventory of various sizes of binding elements may be further multiplied when a user may bind a range of sizes of sheets themselves, i.e., the edges of the sheets to be bound may vary in length.

In order to accommodate varying thicknesses of stacks of sheets to be bound, various binding designs have been proposed. U.S. Pat. No. 2,779,987 to Jordan discloses a first strip from which two prongs extend, which is received in openings in a retaining strip by a ratcheting structure. More commonly used designs, however, typically include a pair of bendable prongs extending from a first strip, which are inserted through openings in the stack of sheets and then into openings in a retaining strip. Each bendable prong is then bent over such that it is disposed substantially adjacent the axis of the retaining strip and then held in position by an interlocking structure or a locking flange or the like, which is slid over the bent end of the prong. Examples of binding structures of this type are disclosed in patents such as the following: U.S. Pat. No. 699,290 to Daniel; U.S. Pat. No. 2,328,416 to Blizard et al.; U.S. Pat. No. 3,224,450 to Whittemore et al.; U.S. Pat. No. 4,070,736 to Land; U.S. Pat. No. 4,121,892 to Nes; U.S. Pat. No. 4,202,645 to Sjöstedt; U.S. Pat. No. 4,288,170 to Barber; U.S. Pat. No. 4,302,123 to Dengler et al.; U.S. Pat. Nos. 4,304,499, 4,453,850, and 4,453,851 to Purcocks; U.S. Pat. No. 4,305,675 to Jacinto; and Great Britain Patent 1,225,120. In such designs, the user can typically reopen the resulting bound structure in order to remove or add further sheets.

A more complex design is disclosed in U.S. Pat. No. 3,970,331 to Giulie. The Giulie design is intended for use in libraries or other institutions for replacing the bindings on books or providing permanent bindings on magazines or the like. The binding structure is designed for assembly without the use of expensive machinery for clamping a book together, or the application of heat or mechanical pressure. The Giulie binding structure includes a pair of backing strips that are positioned along opposite sides of the stack of sheets adjacent preformed holes along one edge of the stack. One of the backing strips includes a plurality of studs having ratchet teeth, the other including a series of holes having a mating ratchet tooth. The studs ratchet through the holes, and a blocking means on the receiving strip is generally broken off of the strip and forced into the opening to permanently couple the studs within the openings. The studs may then be broken off or cut off. Thus, a book formed in this manner cannot be opened to edit the contents and then reengaged. Moreover, such a bound book cannot be readily folded back on itself, or lie open in a surface.

### OBJECTS OF THE INVENTION

It is a primary object of the invention to provide a single binding element that may be utilized to bind a range of book thicknesses. A related object is to provide a binding element that can be readily utilized in an automated feeding arrangement for feeding into an automated binding machine.

A further object of the invention is to provide a binding element that can be readily cut to length, such that an extended length of such a binding element design may be utilized in an automated binding process to bind different lengths of books.

Another object of the invention is to provide a binding element that allows a bound book to lie open on a surface, and a related object is to provide a binding element that permits the bound book to be folded back on itself, the pages turning substantially 360°

An additional object of the invention is to provide a binding element which may be economically and efficiently manufactured.

A further object is to provide a coupled group of binding elements which may be molded using conventional molding techniques.

These and other objects and advantages of the invention will be apparent to those skilled in the art upon reading the following summary and detailed description and upon reference to the drawings.

### BRIEF SUMMARY OF THE INVENTION

The invention provides a binding element that may be readily molded, and utilized to bind in a range of sizes and thicknesses of stacks of sheets. The elements are molded in flat sheets with elongated fingers extending from an elongated spine. The elements may be molded individually, or as an extended length that is then cut to size during an automated assembly process. During assembly, the elongated fingers are inserted into the prepunched openings in the stack of sheets. The free ends of the fingers are then coupled to the spine, shortening the closed finger loop to an appropriate length for the thickness of the stack of sheets. The excess finger is cut from the binding element and discarded. Various designs of binding elements are disclosed herein, although it is not the inventors' intention to limit the invention to only the strict form of the binding elements disclosed herein. Moreover, the actual process steps may be performed in various orders, either sequentially or simultaneously.

These and other objects and advantages of the invention will be apparent to those skilled in the art upon reading the following summary and detailed description and upon reference to the drawings.

### BRIEF DESCRIPTION OF THE DRAWINGS

FIGS. 1A-C are end elevational views of book bindings constructed in accordance with teachings of the inventions.

FIG. 1D is a fragmentary view of a molded binding element illustrating one of the possible manners in which the same may be molded in accordance with teachings of the invention.

FIGS. 1E-G are fragmentary views of the binding elements of FIG. 1D during assembly.

FIGS. 2A-C are views of a first embodiment of a binding element constructed in accordance with teachings of the invention.

FIGS. 3A-C are views of a second embodiment of a book binding element constructed in accordance with teachings of the invention.

FIGS. 4A-C are views of a third embodiment of a book binding element constructed in accordance with teachings of the invention.

FIGS. 5A-B are views of a fourth embodiment of a book binding element constructed in accordance with teachings of the invention.

FIGS. 6A-B are views of a fifth embodiment of a book binding element constructed in accordance with teachings of the invention.

FIGS. 7A-D are views of a sixth embodiment of a book binding element constructed in accordance with teachings of the invention.

FIGS. 8A-B are views of a seventh embodiment of a book binding element constructed in accordance with teachings of the invention.

FIGS. 9A-B are views of an eighth embodiment of a book binding element constructed in accordance with teachings of the invention.

FIGS. 10A-B are views of a ninth embodiment of a book binding element constructed in accordance with teachings of the invention.

FIG. 11 is an enlarged fragmentary perspective view of a tenth embodiment of a book binding element constructed in accordance with teachings of the invention.

FIG. 12 is an enlarged fragmentary perspective view of an eleventh embodiment of a book binding element constructed in accordance with teachings of the invention.

FIGS. 13A-B are views of a twelfth embodiment of a book binding element constructed in accordance with teachings of the invention.

FIGS. 14A-B are views of a thirteenth embodiment of a book binding element constructed in accordance with teachings of the invention.

FIGS. 15A-B are views of a fourteenth embodiment of a book binding element constructed in accordance with teachings of the invention.

FIGS. 16A-C are views of a fifteenth embodiment of a book binding element constructed in accordance with teachings of the invention.

FIGS. 17A-C are views of a sixteenth embodiment of a book binding element constructed in accordance with teachings of the invention.

FIGS. 18A-C are views of a seventeenth embodiment of a book binding element constructed in accordance with teachings of the invention.

FIG. 19 is an enlarged fragmentary perspective view of an eighteenth embodiment of a book binding element constructed in accordance with teachings of the invention.

FIGS. 20A-B are views of a nineteenth embodiment of a book binding element constructed in accordance with teachings of the invention.

### DETAILED DESCRIPTION OF THE INVENTION

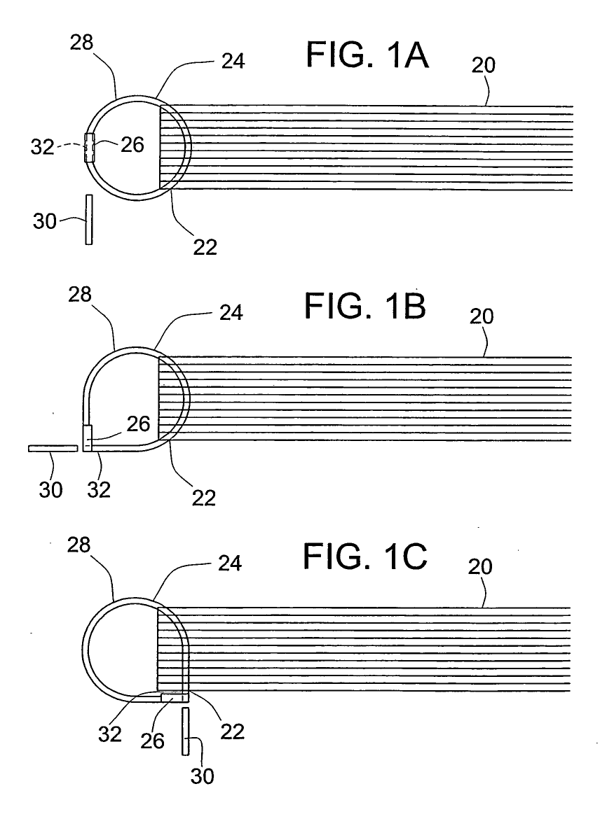

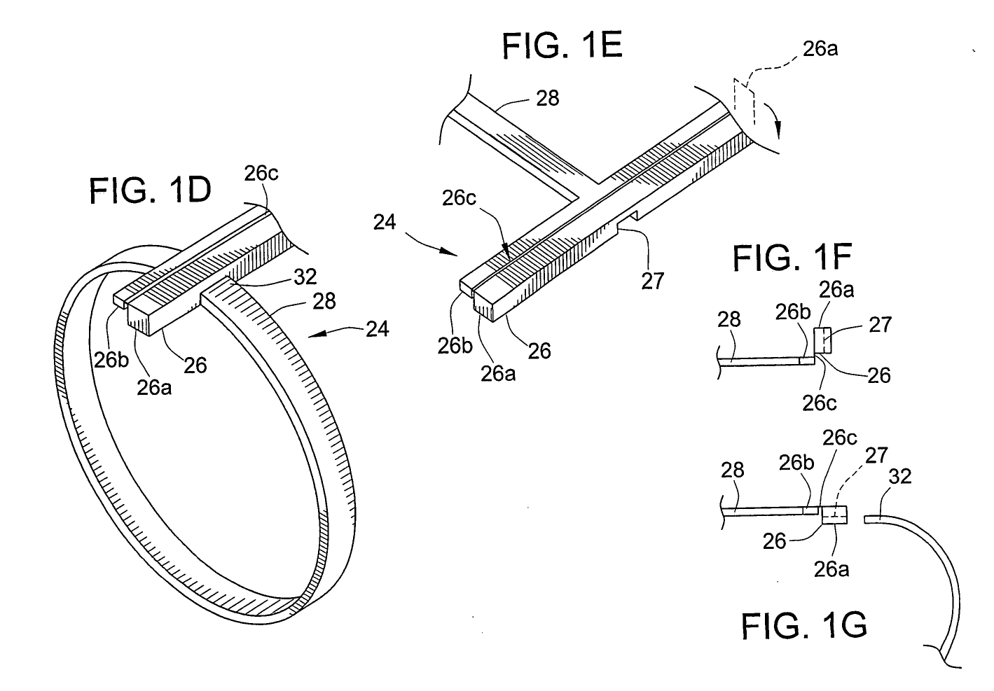

Turning now to the drawings, there is shown in FIGS. 1A-C book bindings constructed in accordance with teachings of the invention. There is shown a stack of sheets 20 having prepunched holes 22 along one edge thereof. The book binding element 24 includes an elongated spine 26 from which a plurality of fingers 28 extend. The fingers 28 are connected to the elongated spine 26 at their base. As shown in the figures, the fingers 28 extend through the openings 22 in the stack of sheets 20 and the distal ends of the fingers 28 are then coupled to the spine to couple the stack 20 together to form a book.

In accordance with the invention, the binding element 24 may be formed in a flat sheet, as shown, for example, by the fragmentary segment illustrated in FIG. 1E. The fingers 28 are then cut to substantially any desired length during the binding process in order to accommodate various sizes of stacks of sheets 20. According to the preferred embodiments as well be discussed herein, the fingers 28 may be disposed substantially parallel to the plane of the spine 26, as shown in FIGS. 1A and 1D, or perpendicular to the plane of the spine 26, as shown in FIGS. 1B and C. During assembly, the fingers 28 are preferably inserted through the openings 22 in the stack of sheets 20 and then a cutting and coupling process performed to cut off the excess length 30 of the finger 28 and to couple the free end 32 of the finger 28 to the spine 26. While the cutting and coupling steps are preferably performed substantially simultaneously, the steps may be performed sequentially in either order. Following the binding procedure, the cut ends 30 may be gathered in a disposal area and discarded.

While the binding elements may be molded by any appropriate methods, one method of molding such a binding element 24 is illustrated in FIGS. 1E-G. In this method of molding, the spine 26 is molded with two portions 26a, 26b coupled by an elongated living hinge 26c. In the mold, the portions 26a, 26b may be disposed perpendicularly one another such that openings 27 for receiving the free ends 32 of the fingers 28 may be molded in a simple two part mold (see FIGS. 1E(phantom)-F). During the assembly process, the two portions 26a, 26b may then be hinged to the same plane, as shown in FIGS. 1D, E, G.

It will further be appreciated, that the binding element 24 may be provided in an extended length such that the spine 26 may be trimmed by the machine to any desired length. Other manners of providing a plurality of binding elements are disclosed in U.S. application No. ______, which is incorporated herein by reference. In this way, the binding elements are not only easily manufactured as the flat element, they are readily utilized in an automated manufacturing process.

The design of the binding elements themselves may be of any appropriate arrangement. For example, the spine itself may be wide or narrow, including a living hinge, or contain slots or openings therethrough for other receiving the free end of the fingers or performing the coupling operation to form a closed loop of a finger. The fingers themselves may have alternate structures, such as a trapezoidal shape, an elongated rectangular shape, square shape, or a round or oval shape. The fingers may have prepunched holes to be utilized in the coupling process, or openings may be punched during the coupling process. The coupling process and structure may include mechanical couplings as well as deformation or heating processes. There is shown in the remaining Figures a plurality of possible binding element designs constructed in accordance with the teachings of the invention. It will be appreciated, however, that additional designs are possible within the spirit and scope of the inventive concept.

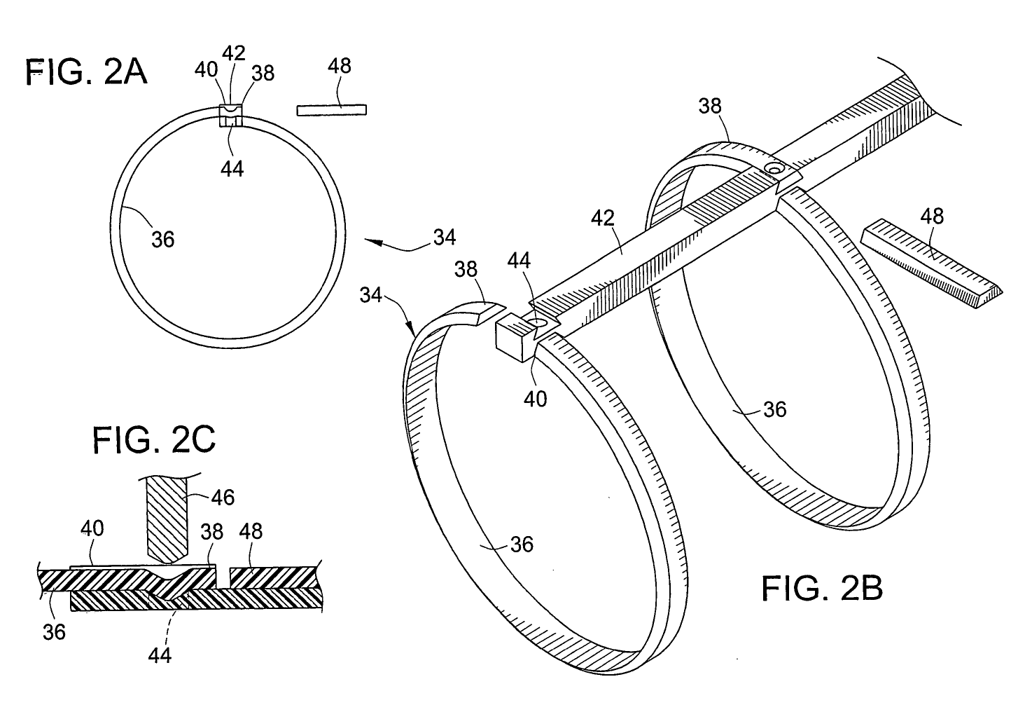

Turning now to FIG. 2A, there is shown an end elevational view of a first embodiment of the binding element 34 constructed in accordance with teachings of the invention. After inserting the finger 36 through the openings in the stack of sheets (not shown), the finger 36 is drawn through the stack and the free end 38 is drawn through a slot 40 in the spine 42 to provide the desired size of closed finger loop. Preferably, a depression or hole 44 is provided at the base of the slot 40. A punch 46, or the like, as shown in FIG. 2C, may be used to deform or punch a portion of the free end 38 into the hole or depression 44 to couple the free end 38 to the spine 42. The excess length 46 of the finger 36 may be trimmed from the free end 38 of the finger 36 to provide a finished appearance. It will be appreciated that the order in which these steps are performed may be modified, and the order explained herein is merely exemplary.

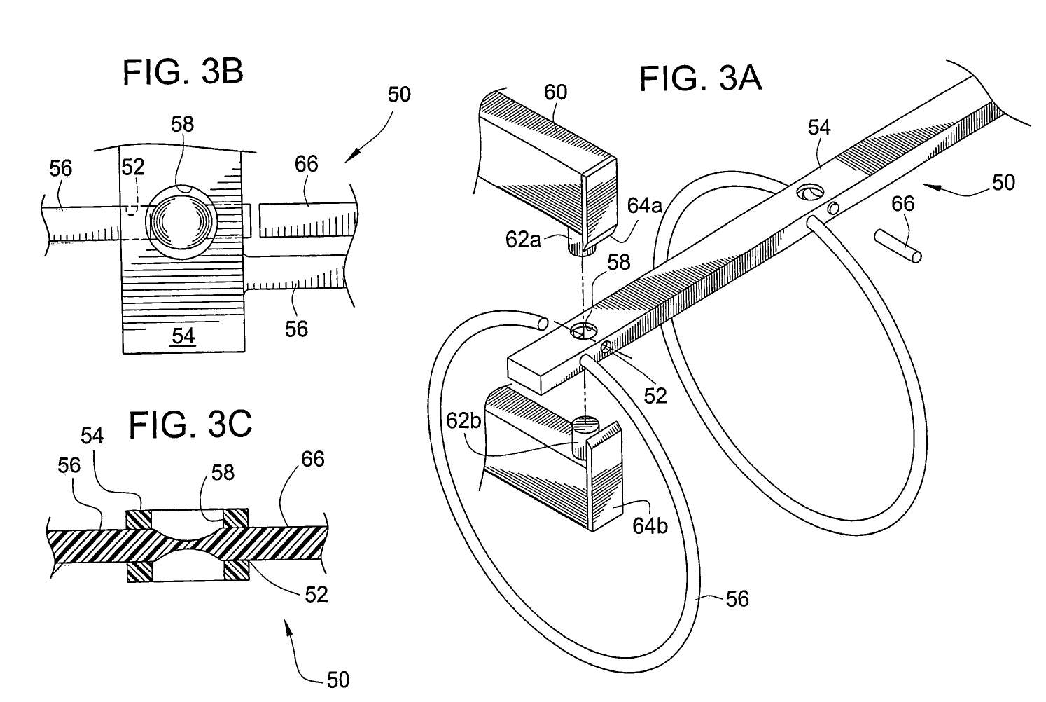

According to a second embodiment illustrated in FIGS. 3A-C, the binding element 50 includes a bore 52 which extends through the spine 54. The bore 52 is sized to receive the free end of the finger 56. The spine 54 further includes a second bore 58 extending at substantially right angle to and through the bore 52. During assembly, a tool 60 having punches 62a, 62b, as well as one or more knives 64a, 64b engages the spine 54 of the binding element 50 such that the punches 62a, 62b are received in the bores 58 and come together to sandwich and flatten a segment of the finger 56 to couple the free end of the finger 56 to the spine 54. Substantially simultaneously, the blades 64a, 64b slide along side the spine 54 and sever the excess length 66 from the end of the finger 56. In the illustrated the ends of the fingers 56 are offset from the bases of the fingers 56 at which they extend from the spine 54. Alternately, if the spine itself is thick enough or if the excess lengths are cut from the free ends of the fingers prior to the coupling process, the free ends and the bases of the fingers may be provided in alignment.

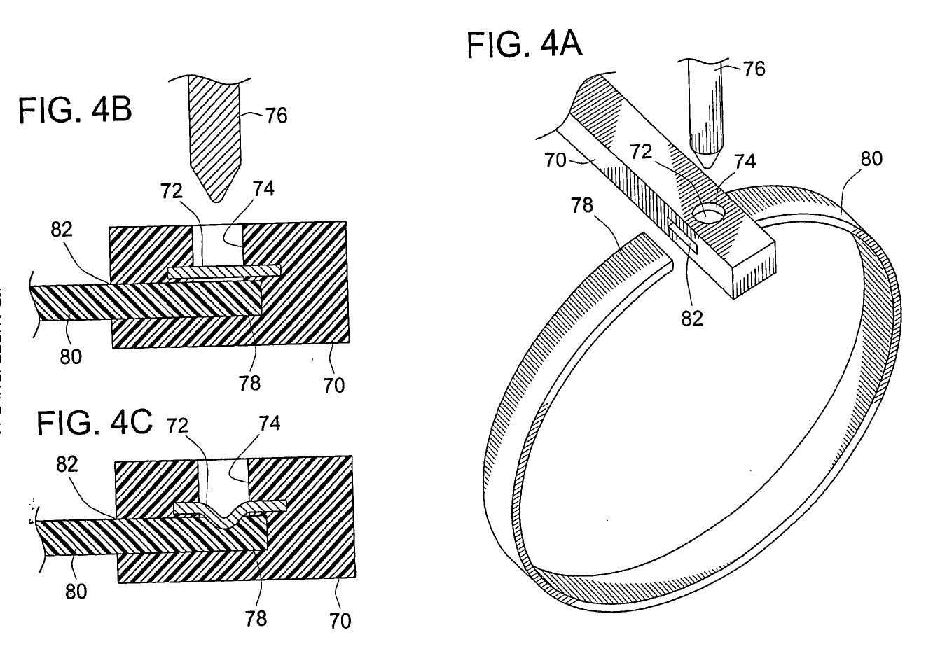

An example of an arrangement where the fingers are cut to length prior to the coupling process is illustrated in FIGS. 4A-C. In this embodiment, the spine 70 alternately includes one or more metal or similar inserts 72 molded therein subjacent a bore 74 which extends only partway through the spine 70. In this way, during the coupling process, the punch 76 is inserted into the bore 74 to deform the metal 72 into the free end 78 of the finger 80 to form the closed finger loop. In this embodiment, the free end 78 of the finger 80 has been trimmed to length prior to inserting it into the opening 82 in the spine 70. It will be appreciated that the excess could be trimmed from the free end 78 of the finger 80 after or during coupling, if the opening 82 extended completely through the spine 70. As illustrated, however, the closed loop of the finger 80 extends from substantially the same position along either side of the spine 70.

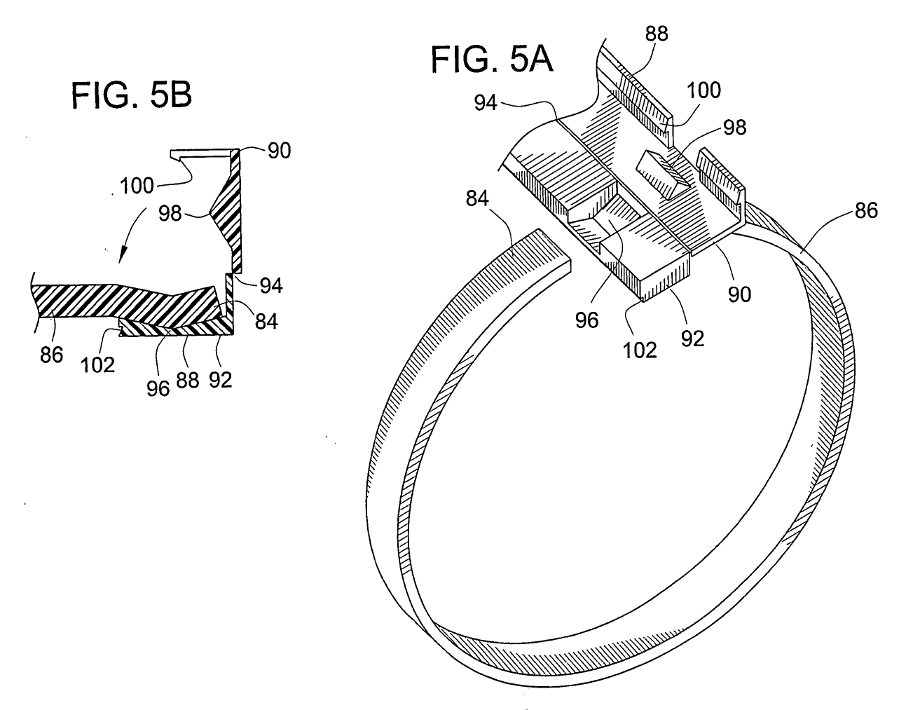

It will be appreciated that in the designs illustrated in FIGS. 2-4, the closed binding element may not readily be disengaged to allow editing of the stack of sheets. The design illustrated in FIGS. 5A-B, however, allows disengagement of the free end 84 of the finger 86 to permit editing. In the illustrated embodiment, the spine 88 comprises two elongated structures 90, 92 coupled by a living hinge 94. The first hinge part 92 includes a trough 96 for receiving the free end 84 of the finger 86, while the second hinge part 90 includes a probe 98, which is disposed to be received in the trough 96 as the second hinge part 90 is pivoted toward the first hinge part 92. In this way, when the free end 84 of the finger 86 is received in the trough 96, the probe 98 deforms the free end 84 into the well of the trough 96 to couple the free end 84 to the spine 88. Preferably, the spine 88 includes an engaging structure for coupling the outer edges of the first and second hinge parts together. In the illustrated embodiment, the second hinge part 90 includes a flange 100 which is received in a depression 102 of the first hinge part to couple the elements together. In this way, the first and second parts 90, 92 may be disengaged to allow access to the free end 84. It will further be appreciated that the design might alternately include a two-piece spine structure that is not hinged, but includes a coupling structure.

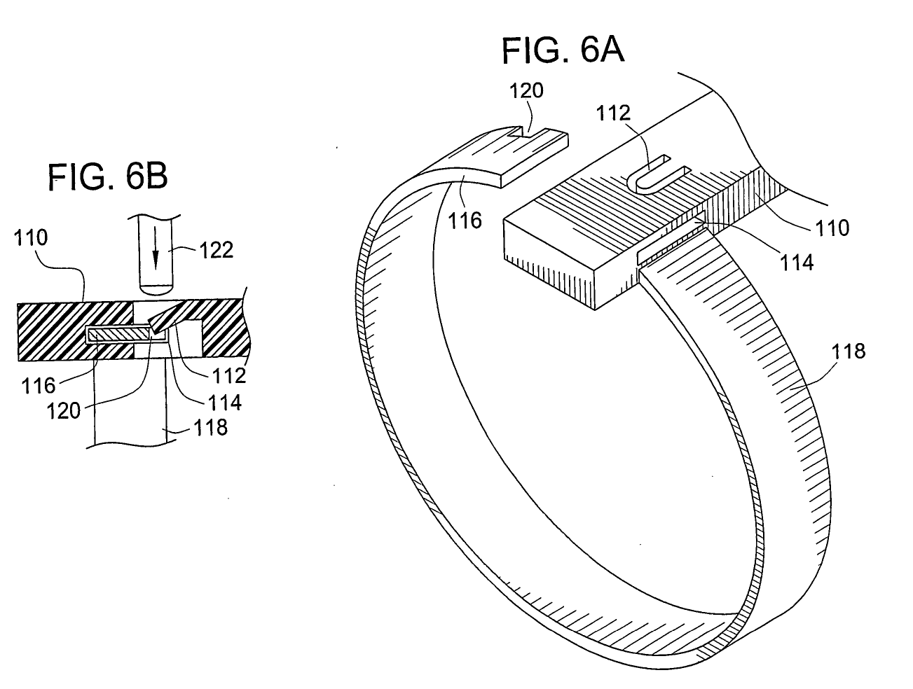

In the embodiment shown in FIGS. 6A and B, the spine 110 includes a molded tab 112 disposed above a bore 114 for receiving the free end 116 of a finger 118. During assembly, the free end 116 of the finger 118 is cut to the appropriate length, and a notch 120 is cut in the side surface of the free end 116. When the free end 116 is inserted into the bore 114, a punch 122 exerts a downward force on the tab 112 to deform the tab 112 into the notch 120 to couple the free end 116 to the spine 110 to form the closed finger.

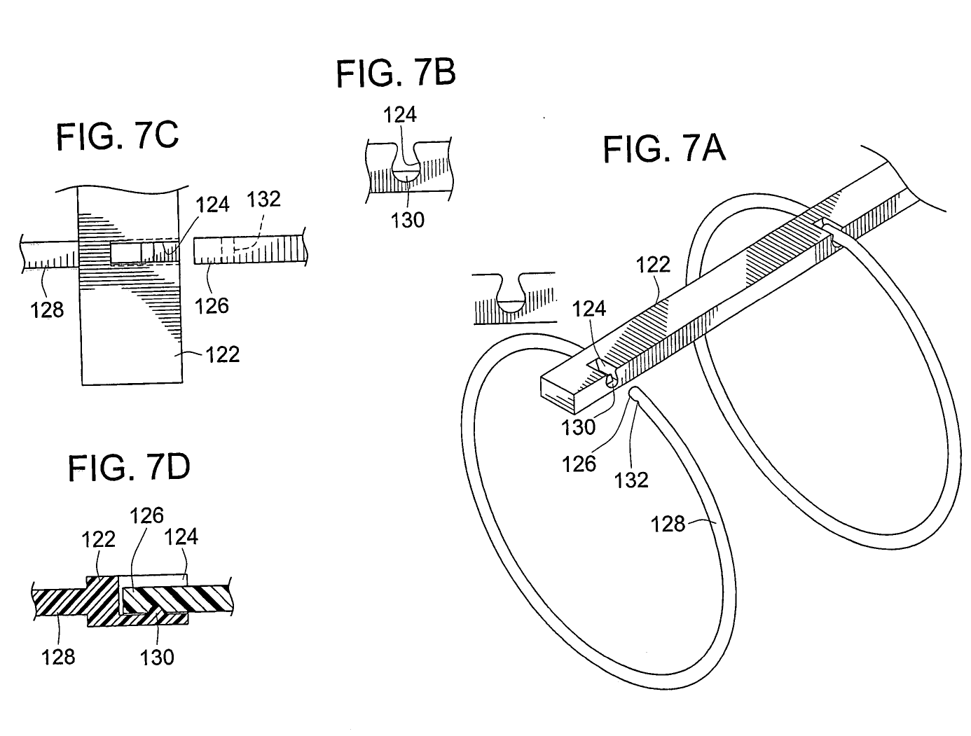

The spine 122 may include an alternate protrusion or collection of protrusions. For example, as illustrated in FIGS. 7A-D, the spine may include a channel 124 shaped to receive and retain the free end 126 of the finger 128 in the longitudinal direction of the spine 122. In this way, the channel 124 provides “protrusions” that are disposed along an upper surface of the finger 128 when assembled, in much the same manner as the embodiment illustrated in FIGS. 2A-C. In the embodiment of FIGS. 7A-D, however, an additional protrusion 130, extending upward from the bottom surface of the channel 124, is provided. During the assembly process, the free end 126 of the finger 128 is cut to provide a notch 132 which engages the protrusion 130 in assembly. It will be appreciated that this embodiment provides an arrangement in which the fingers may be disengaged in order to allow editing. Thus, the channel/protrusion arrangement may assume any number of configurations.

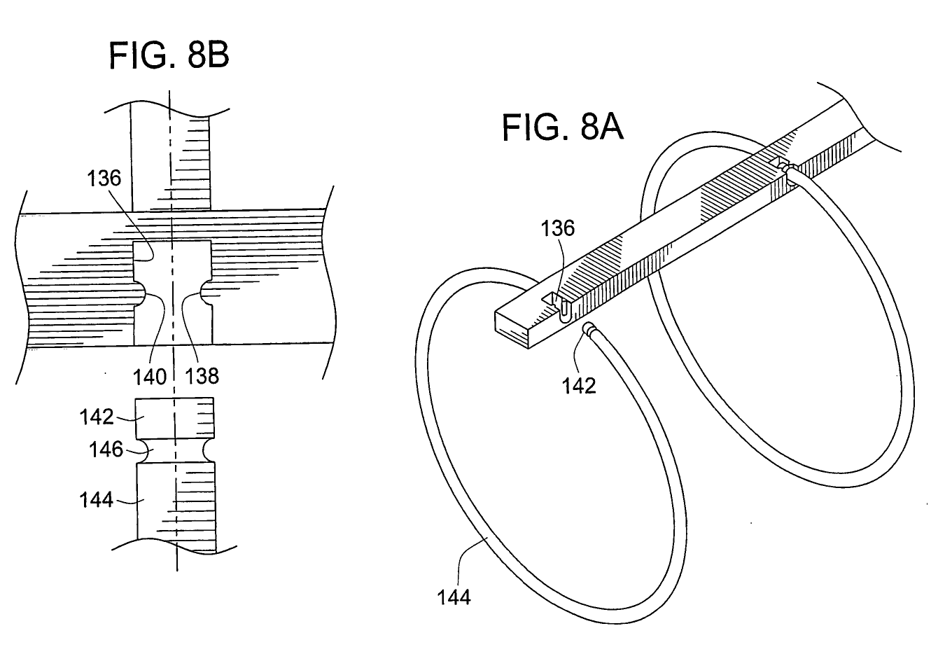

A similar design is shown in FIGS. 8A-B in which the channel 136 includes shaped protrusions 138, 140 extending into the channel 136 from either side. During the assembly process, the free end 142 of the finger 144 is provided with a circumferential channel 146 in which the protrusions 138, 140 are received when coupled. In this design, the fingers may likewise be disengaged in order to allow editing of the stack of sheets.

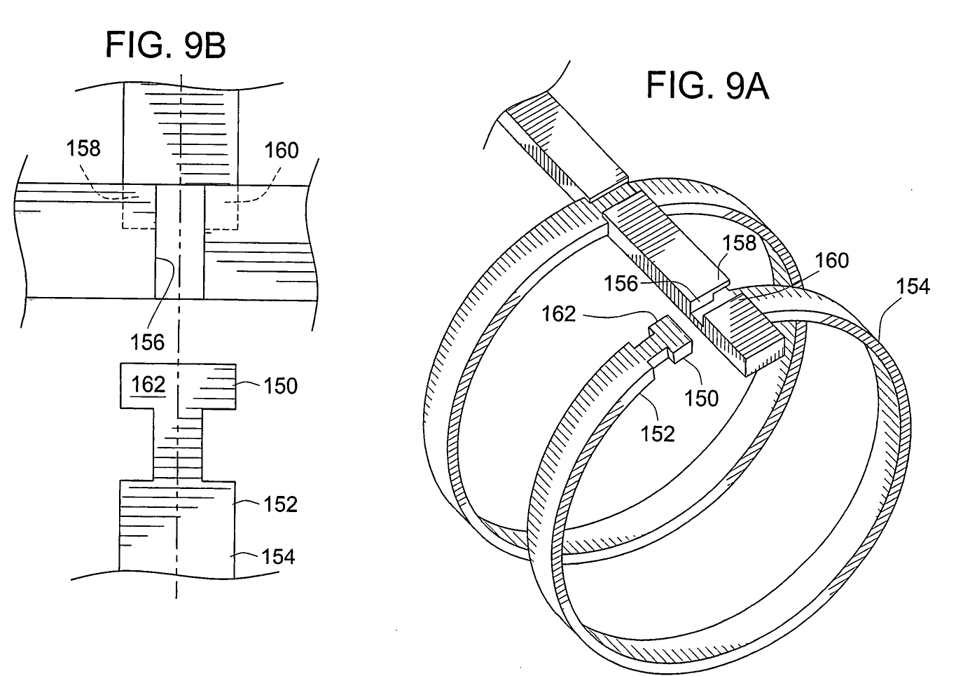

In FIGS. 9A-B, an enlarged T-shaped head 150 is cut at the free end 152 of the finger 154 during the assembly process. The T-shaped head 150 is received in a channel 156 have flanges 158, 160 which are disposed adjacent the head 162 of the “T” when the free end 152 is received. As with the two previous designs, the design illustrated in FIGS. 9A-B may be disassembled in order to allow editing.

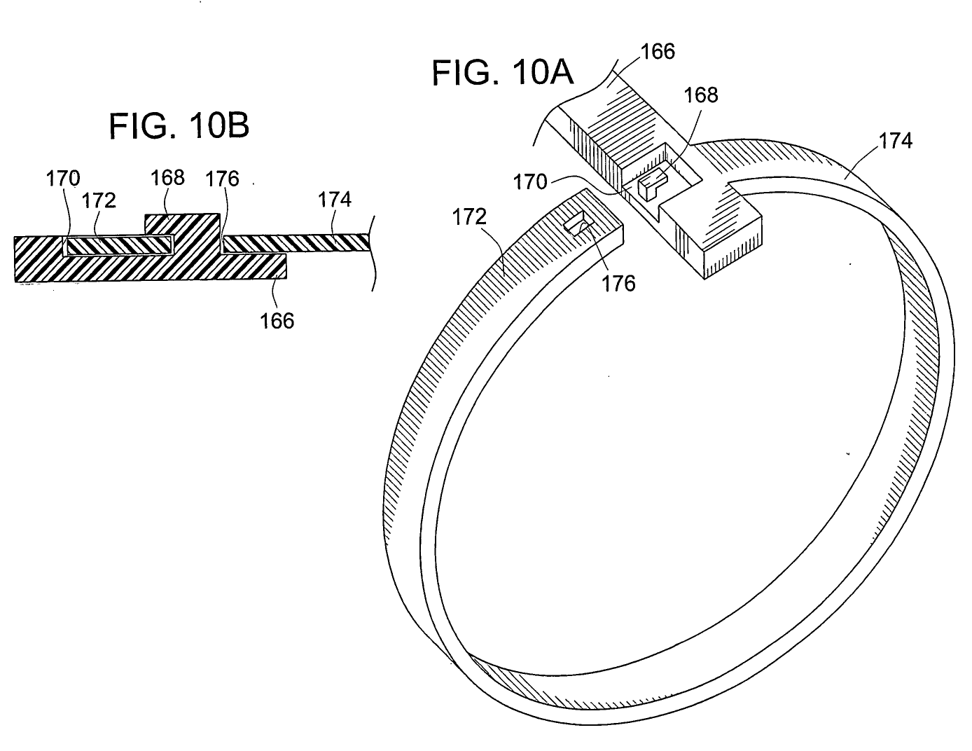

The spine 166 of the embodiment of FIGS. 10A-B includes a protruding hook or flange 168 disposed in a recess 170 in the upper surface of the spine 166. The distal end 172 of the finger 174 may then be punched with an opening 176 therethrough adapted to receive the flange 168 such that the finger loop is formed as the opening 176 of the distal end 172 receives the flange 168 and the distal end 172 is received in the recess 170. As with the three previous designs, the completed finger loops may be disassembled to allow editing of the bound stack of sheets.

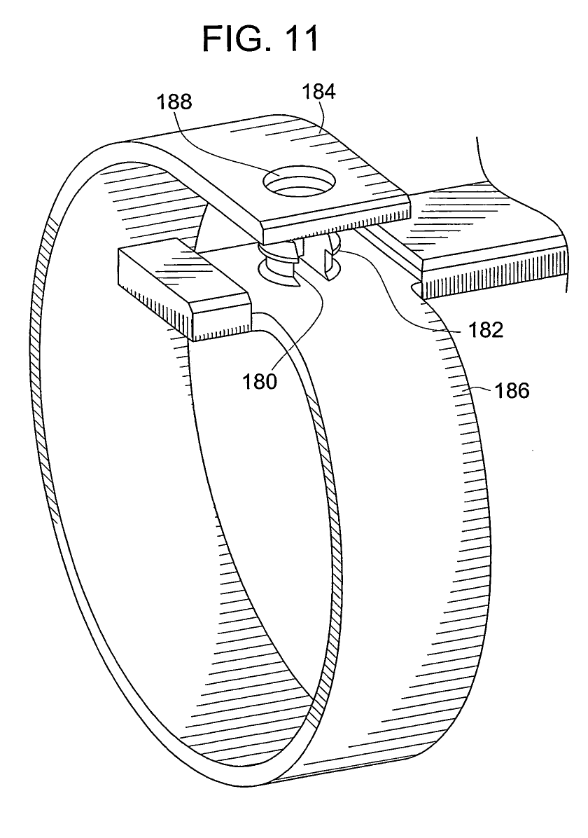

In the embodiment illustrated in FIG. 11, the protrusions 180, 182 are in the form of a pair of flanged protrusions which are biased outward. During the assembly process, the free end 184 of the finger 186 is cut to length and punched with a hole 188 adapted to receive the flanged protrusions 180, 182 when flexed toward one another. After being received in the hole 188, the flanged protrusions 180, 182 return to their original, outwardly biased positions. As with previous designs, the design illustrated in FIG. 11 can be disassembled for editing of the bound stack of sheets.

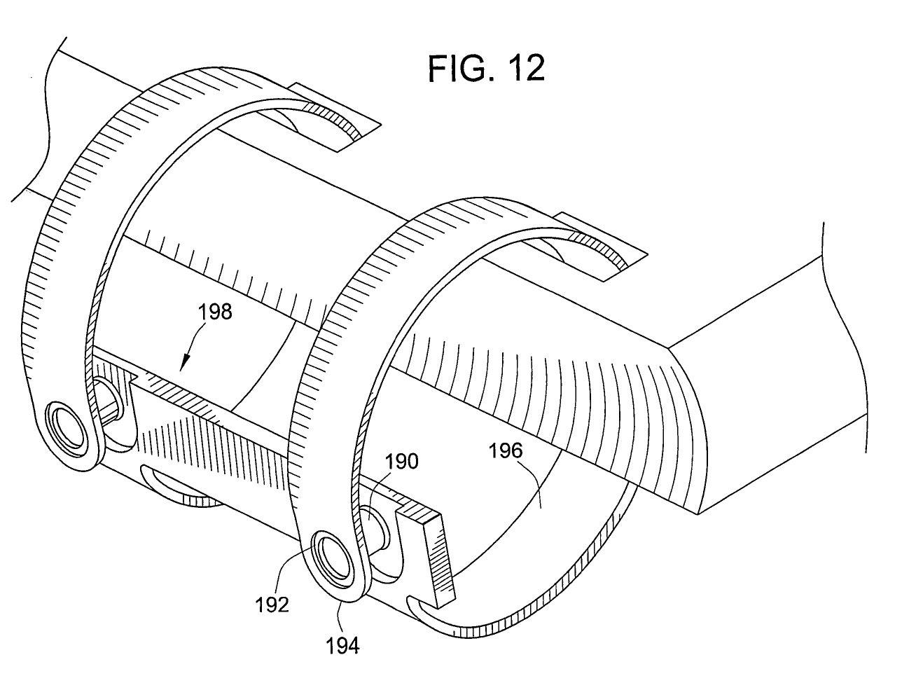

Alternately, the protrusion extending through the opening may be permanently deformed. The protrusion 190 of the embodiment illustrated in FIG. 12 is received in the opening 192 punched in the cut free end 194 of the finger 196. The protrusion 190 may then be swaged or processed with a hot knife to form an enlarged, flattened head. Accordingly, this embodiment is not readily disassembled for editing without damage to the binding strip 198.

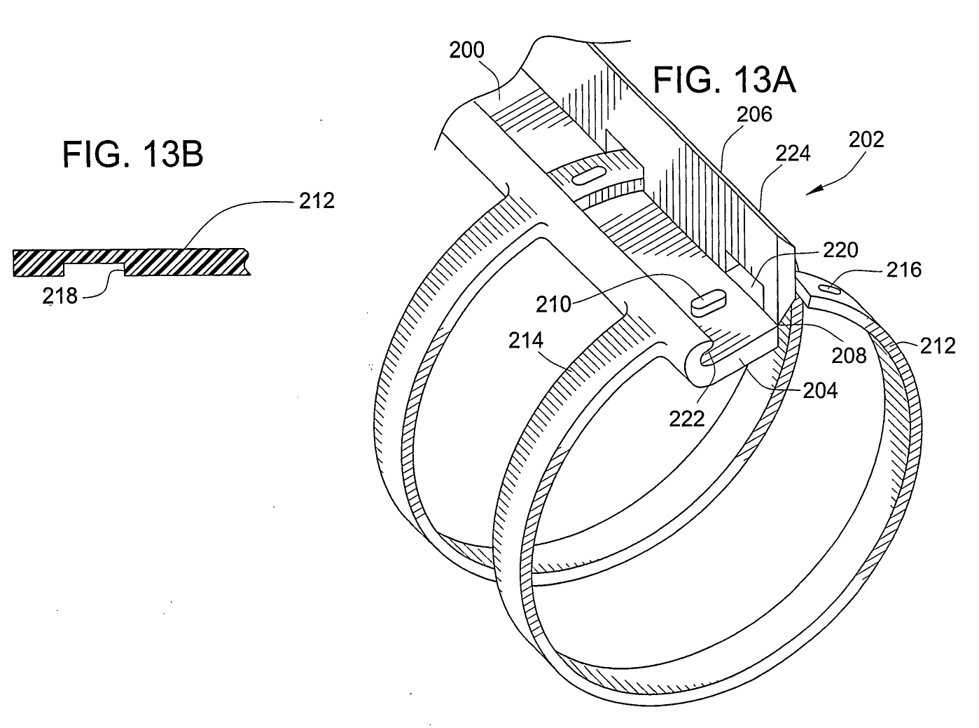

In the embodiment of FIGS. 13A-B, the spine 200 of the binding strip 202 comprises two elongated spine segments 204, 206 preferably coupled by an elongated living hinge 208. The upper surface of the first spine segment 204 is provided with protrusions 210. During the assembly process, preferably, the cut free ends 212 of the fingers 214 are punched with openings 216 sized to receive the protrusions 210, as shown in FIG. 13A. Alternately, the free cut ends of the fingers may be provided with a recess 218, as shown, for example in FIG. 13B. In the illustrated embodiment, a plurality of openings 220 spaced to receive the free ends 212 of the fingers 214 are provided along the living hinge 208. The opposite elongated edge of the first spine segment 204 is provided with an elongated flange 222 disposed to receive and couple the elongated free edge 224 of the second spine segment 206 to the first spine segment 204. Thus, during assembly, the free ends 212 of the fingers 214 are received through the openings 220 along the living hinge 208 and the openings 216 are then positioned over the protrusions 210. The second spine segment 206 is then pivoted toward the first spine segment 204, the elongated free edge 224 of the second spine segment 206 snapping beneath the elongated flange 222 of the first spine segment 206. It will be appreciated that the spine segments could alternately be hinged along the opposite edge, the free edges of the spine segments then including some sort of locking arrangement, such as a series of flanges.

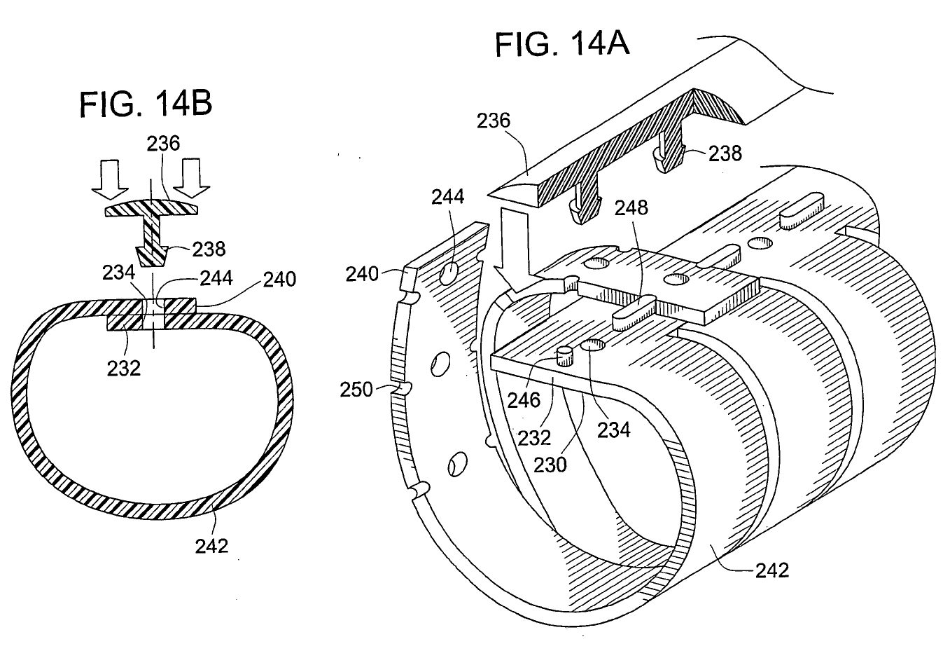

In yet another embodiment, the spine 230 may include two separate elongated sections. In the embodiment illustrated in FIGS. 14A-B, one of the spine segments 232 includes a series of bores 234, while the other spine segment 236 includes a mating series of buttons 238. During the assembly process, the cut free ends 240 of the fingers 242 may likewise be punched with a bore 244 (or the fingers 242 may be prepunched as illustrated), such that the bore 244 may be positioned adjacent one of the bore 234 of the first spine segment 232 and the second spine segment 236 brought together with the first spine segment 232, snapping the button 238 through both bores 244, 234. Alternately, one of the spine segments 232 may be provided with single or elongated protrusions 246, 248, which are received in notches 250 cut along either side of the cut free end 240 of the fingers 242, the other spine segment 236 then being snapped down on the first spine segment 232 to form the closed finger loop.

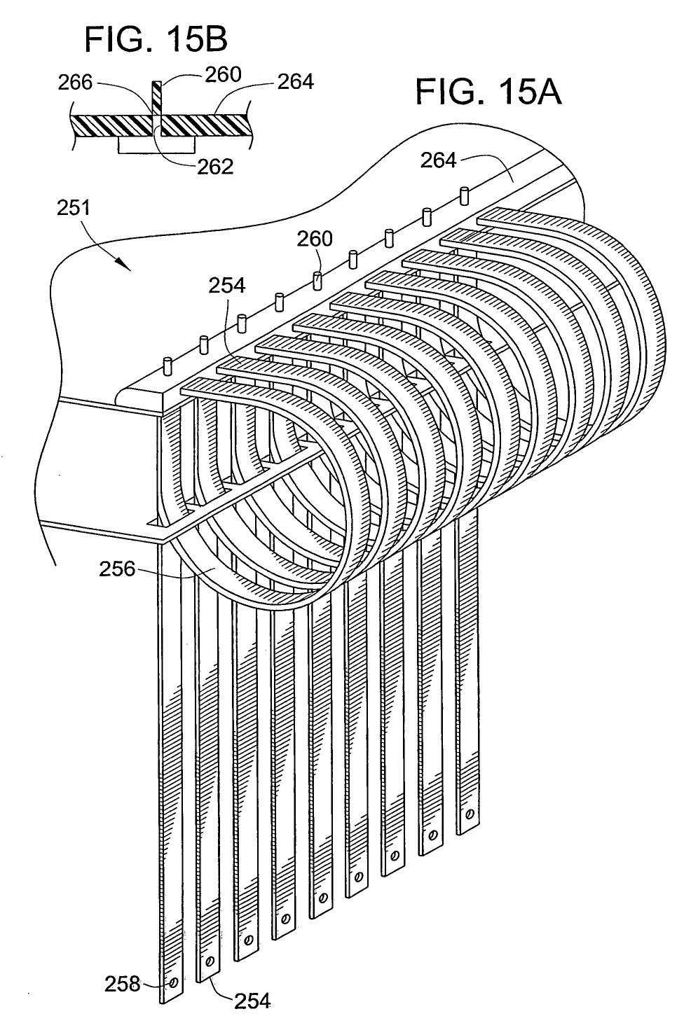

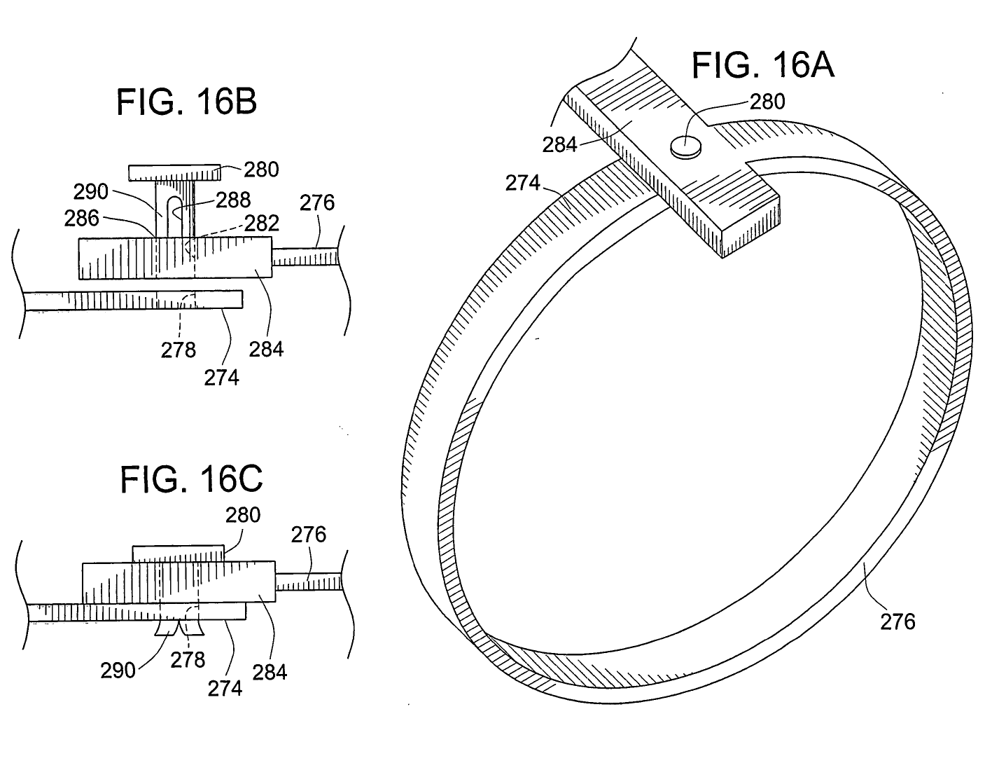

The three embodiments illustrated in FIGS. 15A-17C each include molded parts or pins that are broken away during the assembly process and used to couple the free finger end to the spine. In FIGS. 15A-16C, the cut free ends 254, 274 of the fingers 256, 276 are each punched with a mating opening 258, 278 for receiving the molded pin 260, 280. As may best be seen in FIGS. 15B and 16B, the molded pin 260, 280 is molded adjacent a bore 262, 282 through the spine 264, 284 with a thin material connection 266, 286 therebetween. During the assembly process, the molded pin 260, 280 is broken away as a downward force is applied to the pin 260, 280, breaking the connection 266, 286 and forcing the pin 260, 280 into the subjacent bore 262, 282 and through the punched mating opening 258, 278 in the free end 254, 274 of the corresponding finger 256, 276. In the embodiment of FIGS. 15A and B, the pin 260 has a simple elongated structure, while the pin 280 of the embodiment of FIGS. 16A-C is in the form of a pop rivet with a central channel 288 and a plurality of fingers 290, here two. Accordingly, during assembly of the binding structure 251 of FIGS. 15A-B, the pin 260 is simply pressed into the opening, while the fingers 290 of the pin 280 in FIGS. 16A-C are swaged radially outward during the assembly process to form the closed finger loop.

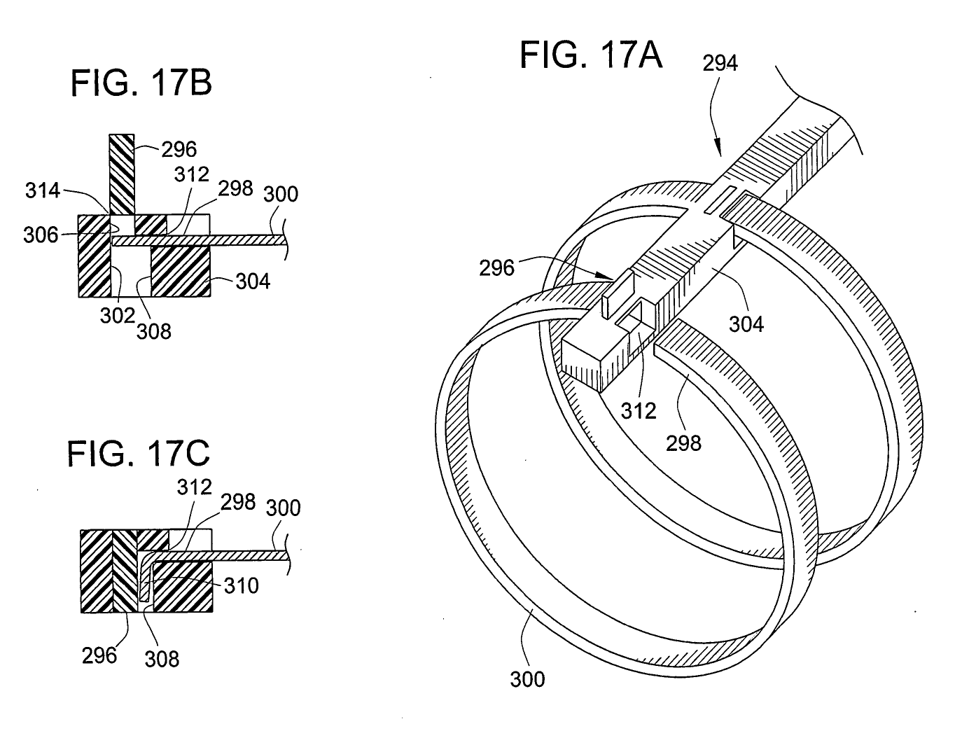

While the binding element 294 of FIGS. 17A-C contains a similar breakaway molded pin 296, the cut free end 298 of the finger 300 does not require an opening therethrough for assembly. Rather, the channel 302 in the spine 304 subjacent the molded pin 296 includes not only a portion 306 for receiving molded pin 296, but also a portion 308 for receiving a bent end 310 of the free end 298 of the finger 300. In this way, during the assembly process, the free end 298 is inserted into an alternate opening 312 in the spine 304, and then a downward force on the pin 296 breaks the molded connection 314 between the pin 296 and the spine 304. The pin 296 is thus forced down into the subjacent channel 302 to bend the free end 298 of the finger 300 downward and secure the bent end 310 in the cavity bounded by the channel portion 308 and the pin 296.

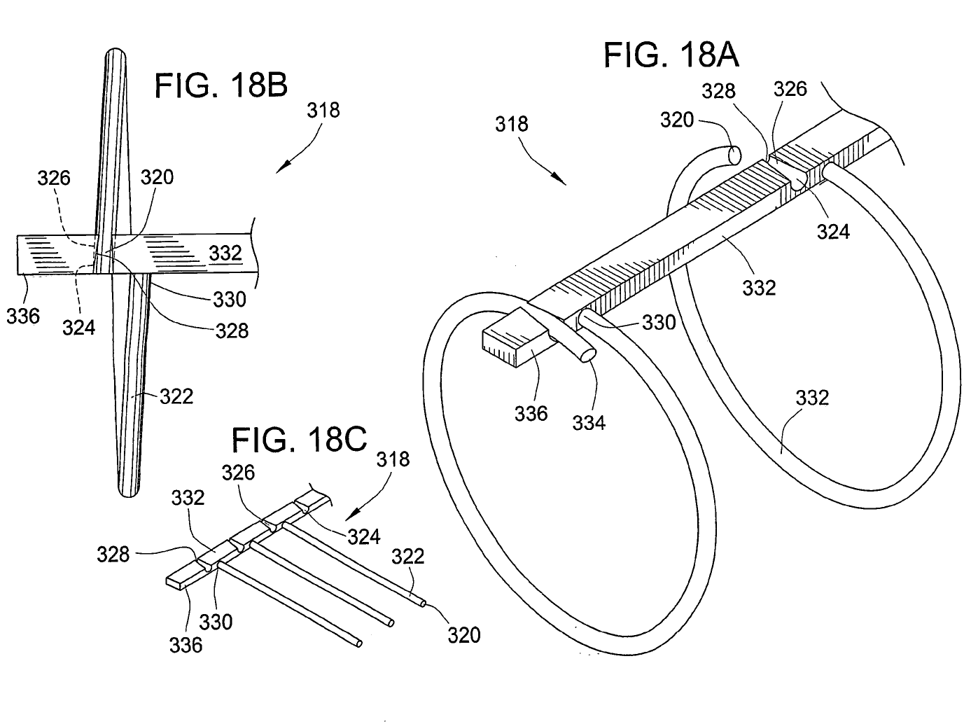

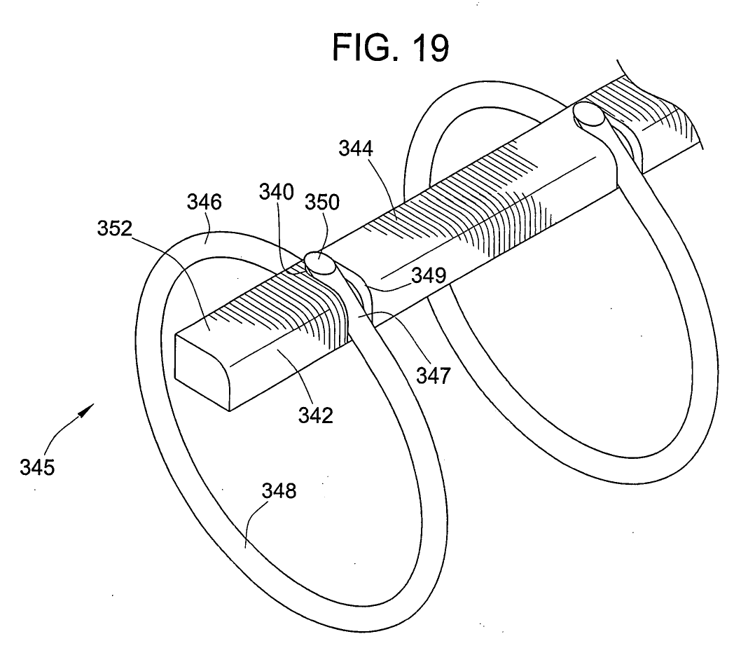

In the embodiments illustrated in FIGS. 18A-19, the free ends 320, 347 of the fingers 322, 348 are pressed into troughs 324, 340. The troughs 324, 340 are shaped to closely receive the fingers 322, 348, and have a portion 326 which is smaller than the cross-section of the fingers 322, 348 themselves. As described above with regard to earlier embodiments, the shape of the troughs 324, 340 may include protrusions 328, 349 from either side of the trough 324, 340, disposed such that the finger 322, 348 is subjacent the protrusions 328, 349 in the assembled state. In these embodiments, the spine 332, 344 preferably includes a comparatively harder plastic, while the fingers 322, 348 preferably include a comparatively softer plastic. In this way, the fingers 322, 348 may be slightly deformed as the free ends 320, 347 are pressed into the troughs 324, 340. For example, the binding element 318, 345 may be co-molded with a hard styrene spine 332, 344 and relatively soft polypropylene fingers 322, 348, although other materials may be utilized.

In the embodiment of FIGS. 18A-C, the troughs 324 are offset from the bases 330 of the fingers 322 along the spine 332, and the excess 334 from the free ends 320 of the fingers 322 may be cut from side surface 336 of the spine 332 substantially simultaneously with the pressing of the free ends 320 into the troughs 324. Conversely, in the embodiment of FIG. 19, the troughs 340 are angled along one edge 342 of the spine 344 and provided along substantially the same line as the base 346 of the fingers 348. In this way the excess finger length may be cut at 350 from the top surface 352 of the spine 344 during assembly, rather than from the side as in FIGS. 18A-C.

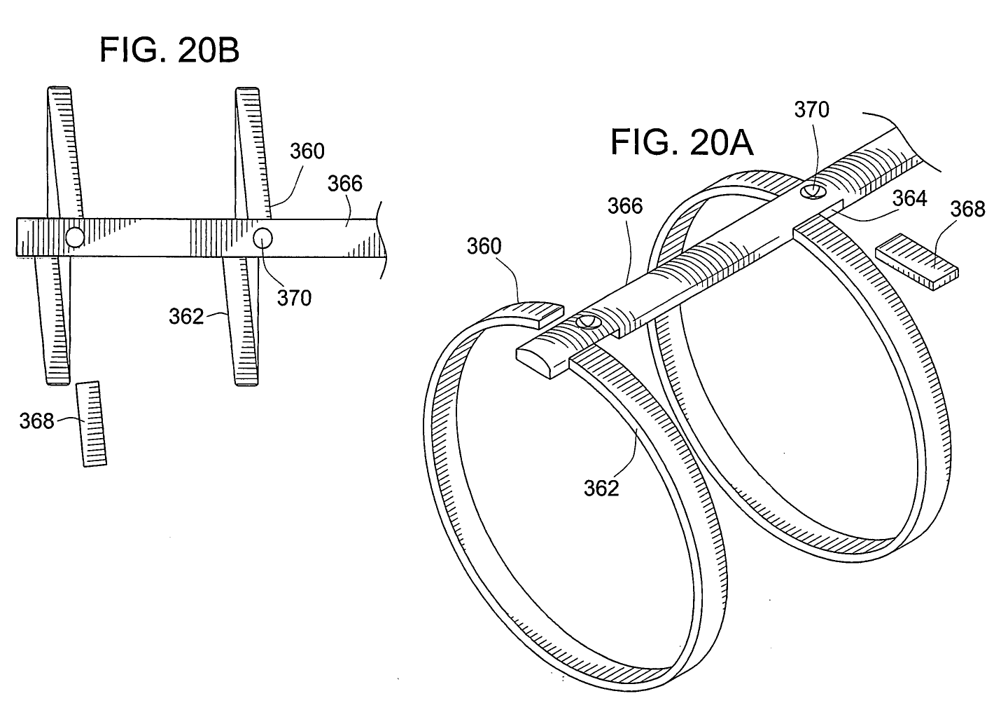

Alternately, as shown in FIGS. 20A-B, the free ends 360 of the fingers 362 may be received in bores through or troughs 364 in the upper or lower surface of the spine 366 and then sonically welded, or the like. In the illustrated embodiment, the excess 368 of the free end 360 need only be cut and no further operation performed on the free end 360 itself, other than the sonic welding process at 370.

While this invention has been described with an emphasis upon preferred embodiments, variations of the preferred embodiments can be used, and it is intended that the invention can be practiced otherwise than as specifically described herein. Accordingly, this invention includes all modifications encompassed within the spirit and scope of the invention as defined by the following claims.

All of the references cited herein, including patents, patent applications, and publications, are hereby incorporated in their entireties by reference.

We claim as our invention:

1. A method of binding a stack of sheets having a thickness and having a plurality of perforations, said stack of sheets having a potential range of thicknesses, said range of thickness including a relatively thick stack of sheets and a relatively thin stack of sheets, the method comprising the steps of
providing a binding element having an elongated spine, and a plurality of elongated fingers extending from said spine, said fingers having base adjacent the spine, and a free distal end opposite the base,
inserting said fingers through the perforations in said stack of sheets,
cutting the fingers to a desired length sufficient to accommodate the stack of sheets, and
locking the distal ends of the fingers to the elongated spine.

2. The method of claim 1 wherein the cutting step is performed prior to the locking step.

3. The method of claim 1 wherein the cutting step is performed subsequent to the locking step.

4. The method of claim 1 wherein the cutting step and the locking step are performed substantially simultaneously.

5. The method of claim 1 wherein the locking step includes the step of ultrasonically welding the finger to the elongated spine.

6. The method of claim 1 wherein the locking step includes the step of plastically deforming at least one of the finger or the elongated spine.

7. The method of claim 1 wherein the locking step includes the step of press fitting the finger into an opening in the elongated spine.

8. The method of claim 1 wherein the locking step includes the step of heating at least one of the finger or the elongated spine.

9. The method of claim 1 wherein the locking step includes the step of bending at least one finger.

10. The method of claim 1 wherein the locking step includes the step of deforming a metallic insert in the spine.

11. The method of claim 1 wherein the locking step includes the step of cutting a notch in the finger.

12. The method of claim 1 wherein the locking step includes the step of inserting a pin between the finger and the spine.

13. The method of claim 1 wherein the locking step includes the steps of inserting the finger into a slot in the spine.

14. The method of claim 1 wherein the spine includes at least two hingedly-coupled portions, and the locking step includes the steps of inserting at least one finger into an opening in the spine and drawing the hingedly coupled portions toward one another.

15. The method of claim 12 wherein the pin is a pop-rivet.

16. The method of claim 12 wherein the pin is molded with the binding element.

17. The method of claim 16 wherein the locking step includes the step of separating the pin from the binding element, and inserting the pin between the finger and the spine.

18. A binding element for binding a stack of sheets having a thickness and having a plurality of perforations, said stack of sheets having a potential range of thicknesses, said range of thickness including a relatively thick stack of sheets and a relatively thin stack of sheets, the binding element comprising
an elongated spine,
a plurality of elongated fingers extending from said spine, said fingers having base adjacent the spine, and a free distal end opposite the base, said distal end being adapted to be inserted through the perforations and to be coupled to the spine to form a closed finger loop, said fingers being sufficiently long to bind the relatively thick stack of sheets,
a coupling mechanism, said plurality of elongated fingers being adapted to be cut to a desired length to bind said stack of sheets within said potential range of thicknesses.

19. The binding element of claim 18 wherein the fingers include channels to facilitate cutting the finger to a desired length.

20. The binding element of claim 18 wherein the spine includes at least one slot for receiving the finger.

21. The binding element of claim 18 wherein the spine includes at least on opening for receiving the finger.

22. The binding element of claim 18 wherein the finger includes a notch.

23. The binding element of claim 18 wherein the spine further comprises a metal insert.

24. The binding element of claim 22 wherein the spine further includes a protrusion that is received in the notch of the finger.

25. The binding element of claim 18 wherein at least one of the fingers includes a protrusion and the spine includes at least one notch, the notch being received in the finger during coupling.

26. The binding element of claim 18 further including a pin, said pin being disposed between the finger and the spine when the finger is coupled to the spine to form said closed finger loop.

27. The binding element of claim 26 wherein the pin is molded with the binding element bent into position between the finger and the spine.

28. The binding element of claim 26 wherein the pin is molded with the binding element and severed therefrom for placement between the finger and the spine.

29. The binding element of claim 18 wherein at least one of the spine or the fingers are plastically deformable.

30. The binding element of claim 18 wherein the fingers and spine include a ratching mechanism.

31. The binding element of claim 18 wherein the spine includes at least two hingedly-coupled elongated portions and at least one opening for receiving the finger, said two hingedly-coupled portions being moveable relative to one another to sandwich the finger inserted in the opening.

32. The binding element of claim 18 wherein the finger includes a necked down portion and an enlarged distal end, and the spine includes a recess sized to receive the necked down portion and the enlarged distal end.

33. A plurality of binding elements as claimed in claim 18 wherein the elongated spine is adapted to be cut to a desired length for binding a stack of sheets.

34. The method of claim 1 further comprising the step of cutting the elongated spine to a desired length to accommodate the stack of sheets to be bound.
